(19) United States
(12) Patent Application Publication
(10) Pub. No.: US 2007/0170631 A1
(43) Pub. Date: Jul. 26, 2007

(54) Bookbinding apparatus and image forming system

(75) Inventors: Norishige Kato, Tokyo (JP); Tetsuo Hirata, Tokyo (JP); Motoki Nakamichi, Tokyo (JP); Takehiro Ogushi, Tokyo (JP); Yasushi Saitsu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/586,682

(22) Filed: Oct. 26, 2006

(30) Foreign Application Priority Data
Jan. 18, 2006 (JP) JP2006-009671

(51) Int. Cl. B41L 43/12

(52) U.S. Cl. 270/37

(57) ABSTRACT

A bookbinding apparatus that binds a book by stacking a plurality of sheets to generate a bundle of sheets, and by wrapping the aforesaid bundle of sheets with a cover sheet in a U-shaped form, wherein there are provided the first holding member for holding the bundle of sheets, the second holding member that is arranged to have an initial gap between itself and the first holding member at an initial position, a moving device that moves at least the second holding member from its initial position, a measuring device that measures a thickness of the bundle of sheets by causing the moving device to operate so that the first holding member and the second holding member may hold the bundle of the sheets and a control device that practices measurement operation to measure the initial gap between the first holding member and the second holding member.

This application is based on Japanese Patent Application No. 2006-009671 filed on Jan. 18, 2006 in Japanese Patent Office, the entire content of which is hereby incorporated by reference.

### BACKGROUND OF THE INVENTION

The present invention relates to a bookbinding apparatus and an image forming system wherein a bundle of sheets are wrapped with a cover sheet in a U-shaped form for bookbinding.

A bookbinding apparatus is commonly known that binds a book simply by wrapping a bundle of plural sheets (text sheets) having thereon images formed by a copying machine or a printer, with a cover sheet in a U-shaped form (see Patent Document 1). The following is an explanation of an outline of general bookbinding technologies. First, a plurality of sheets having thereon images formed are stacked and aligned. Then, adhesive such as paste is coated on one surface of a bundle of sheets stacked and aligned. Then, a cover sheet is transported and then stopped at a prescribed position to be joined with the surface of the bundle of sheets where the adhesive has been coated. Through the aforesaid procedures, the plural sheets are integrated with the cover sheet to become a book.

FIG. 1 shows an example of a book that is bound by the bookbinding apparatus. Book S3 is composed of a bundle of plural sheets S1 and cover sheet S2, and end on spread side S1E of sheets S1 and end on spread side S2E of cover sheet S2 are aligned. For the purpose of aligning S1E and S2E together as shown in FIG. 1, the cover sheet needs to be cut to the prescribed length, and a length of the cover sheet after being cut needs to be in a value equivalent to the sum of the double of a width (X shown in FIG. 1) of sheets S1 and a thickness (Y shown in FIG. 1) of the bundle of sheets S1. Since the sheet S1 is usually in a fixed size, a width (X shown in FIG. 1) of sheets S1 is automatically determined when a sheet size is selected. However, a thickness (Y shown in FIG. 1) of the bundle of sheets S1 varies depending on the number of sheets S1 to be printed. It is therefore necessary to measure a thickness of the bundle of sheets S1 for aligning S1E and S2E accurately.

FIG. 2 shows an example of a method of measuring a thickness of a bundle of sheets S1. The measuring method shown in FIG. 2 is one to measure a thickness of a bundle of sheets S1 by holding sheets S1 with two plates I1 and I2. Plates I1 and I2 are separated from each other with initial gap “A” at first. When a plurality of sheets S1 are stacked, plate I2 is moved in the direction of an arrow. Then, the plate I2 is stopped at the position where the plate I2 comes in contact with the sheets S1, to measure travel distance “B” of the plate I2. Thus, a value obtained by subtracting the travel distance “B” of the plate I2 from the initial gap “A” represents a thickness of the bundle of sheets S1.

In the method of measuring a thickness of a bundle of sheets S1 shown in FIG. 2, initial gap “A” between plate I1 and plate I2 varies subtly in every machine, because of an influence of parts accuracy. Therefore, if initial gap “A” is not measured for every machine, a thickness of a bundle of sheets S1 cannot be measured accurately, and end on spread side S1E and end on spread side S2E on book S3 are not aligned.

[Patent Document 1] Unexamined Japanese Patent Application Publication No. 2005-335262

### SUMMARY

An objective of the present invention therefore is to provide a bookbinding apparatus and an image forming system capable of measuring a thickness of a bundle of sheets accurately.

For attaining the aforesaid objective, a bookbinding apparatus relating to the invention is a bookbinding apparatus that binds a book by stacking a plurality of sheets to generate a bundle of sheets, and by wrapping the aforesaid bundle of sheets with a cover sheet in a U-shaped form, wherein there are provided the first holding member for holding the bundle of sheets, the second holding member that is arranged to have an initial gap between itself and the first holding member at an initial position, a moving device that moves at least the second holding member from its initial position, a measuring device that measures a thickness of the bundle of sheets by causing the moving device to operate so that the first holding member and the second holding member may hold the bundle of the sheets and a control device that practices measurement operation to measure the size of the initial gap between the first holding member and the second holding member.

An image forming system relating to the invention is one in which a bookbinding apparatus that binds a book by stacking a plurality of sheets to generate a bundle of sheets, and by wrapping the aforesaid bundle of sheets with a cover sheet in a U-shaped form and an image forming apparatus that forms images on a sheet are connected to each other wherein there are provided the first holding member for holding the bundle of sheets, the second holding member that is arranged to have an initial gap between itself and the first holding member at an initial position, a moving device that moves at least the second holding member from its initial position, a measuring device that measures a thickness of the bundle of sheets by causing the moving device to operate so that the first holding member and the second holding member may hold the bundle of the sheets and a control device that practices measurement operation to measure the size of the initial gap between the first holding member and the second holding member.

### BRIEF DESCRIPTION OF THE DRAWINGS

FIG. 1 is a side view of book S3.

FIG. 2 is an illustration of a method to measure a thickness of a bundle of sheets S1.

FIG. 3 is a central sectional-view of an image forming system.

FIG. 4 is a front sectional-view of bookbinding apparatus B.

FIG. 5 is an illustration showing processes of coating adhesive on a bundle of sheets S1.

FIG. 6 is an illustration showing coating operations for adhesive 63 by coating section 60.

FIG. 7 is an illustration showing how cover sheet S2 is joined.

FIG. 8 is an illustration showing how cover sheet S2 is joined.

FIG. 9 is a top view of a cover sheet supporting device.

FIG. 10 is an illustration showing processing of a cover sheet after being joined.

FIG. 11 is a block diagram of a control system in an image forming system.

FIG. 12 is a flow chart showing operations for measuring a thickness of a bundle of sheets S1.

FIG. 13 is an illustration concerning operations of the first holding member 502 and the second holding member 503.

FIG. 14 is a flow chart showing operations for measuring initial gap “A” by using a timer.

### DETAILED DESCRIPTION OF THE PREFERRED EMBODIMENT

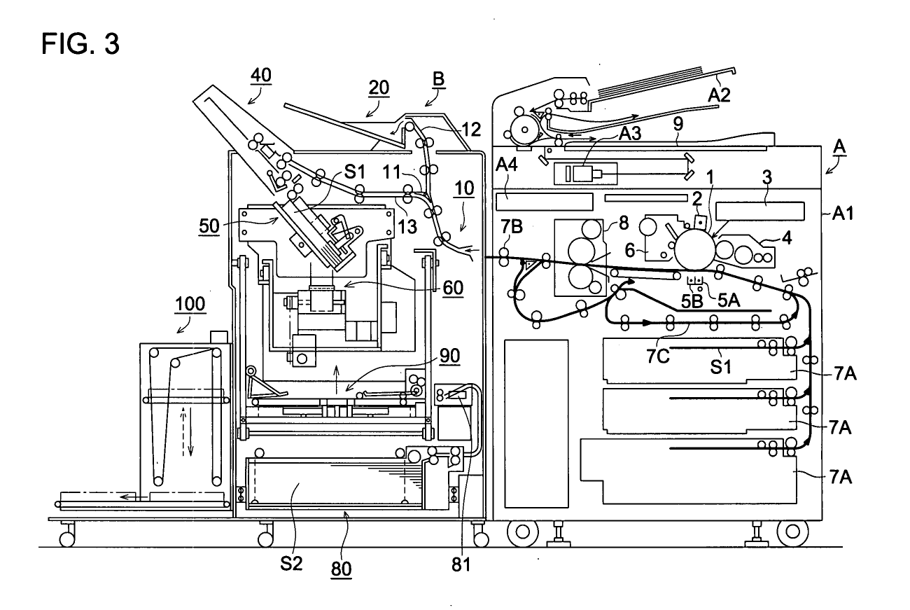

FIG. 3 is a central sectional-view of an image forming system.

The image forming system has therein image forming apparatus A and bookbinding apparatus B.

The image forming apparatus A is one for forming an image on a sheet through an electrophotographic method, and it is composed of image forming section A1, document conveyance device A2, image reading section A3 and communication section A4. In the image forming section A1, there are arranged, around drum-shaped photoreceptor 1, charging device 2, exposure device 3, developing device 4, transfer device 5A, separation device 5B and cleaning device 6, whereby, respective processes such as charging, exposure, developing and transfer are carried out, and a toner image is formed on sheet S1. Sheets S1 are loaded in three sheet-feeding trays 7A, and the sheets are fed out one by one from sheet-feeding tray 7A to be conveyed to image forming section A1. Sheet S1 onto which a toner image is transferred passes through fixing device 8 to be subjected to fixing processing. The sheet S1 subjected to fixing processing is either ejected out of image forming apparatus A from sheet-ejection roller 7B, or conveyed to sheet-refeeding path 7C.

Bookbinding apparatus B is an apparatus to form a book by binding plural sheets fed in from image forming apparatus A into a bundle of sheets and by wrapping the bundle of sheets in a U-shaped form with a cover sheet joining with the bundle. The bookbinding apparatus B is composed of sheet-reversing section 40, sheet-stacking section 50, coating section 60, and joining section 90 that joins a cover sheet with a bundle of sheets, and is further composed of conveyance section 10, sheet-ejection tray 20, cover sheet loading section 80 and book-ejection section 100. Sheet S1 conveyed to bookbinding apparatus B from image forming apparatus A is either ejected to sheet-ejection tray 20 through sheet-ejection path 12 or conveyed to sheet-reversing section 40 by being distributed with switching gate 11 provided in conveyance section 10. To the sheet-ejection tray 20, sheet S1 is ejected when no bookbinding is carried out in bookbinding apparatus B. When bookbinding is carried out in the bookbinding apparatus B, sheet S1 is conveyed to sheet-reversing section 40 through conveyance path 13, and is conveyed to stacking section 50 after tracing a switchback in the sheet-reversing section 40. Sheets S1 are stacked in stacking section 50 and when the number of sheets S1 arrives at an established value, the stacking section rotates, and the bundle of sheets S1 is held substantially vertically. Then, adhesive is coated by coating section 60 on the bottom surface representing a spine of the bundle of sheets S1, thus, cover sheet S2 comes in contact with the bundle of sheets S1 to be bonded thereto. Book S3 in which cover sheet S2 is bonded to the bundle of sheets S1 is ejected to book-ejection section 100.

After explaining the structure of bookbinding apparatus B, a process through which book S3 is formed will be explained as follows.

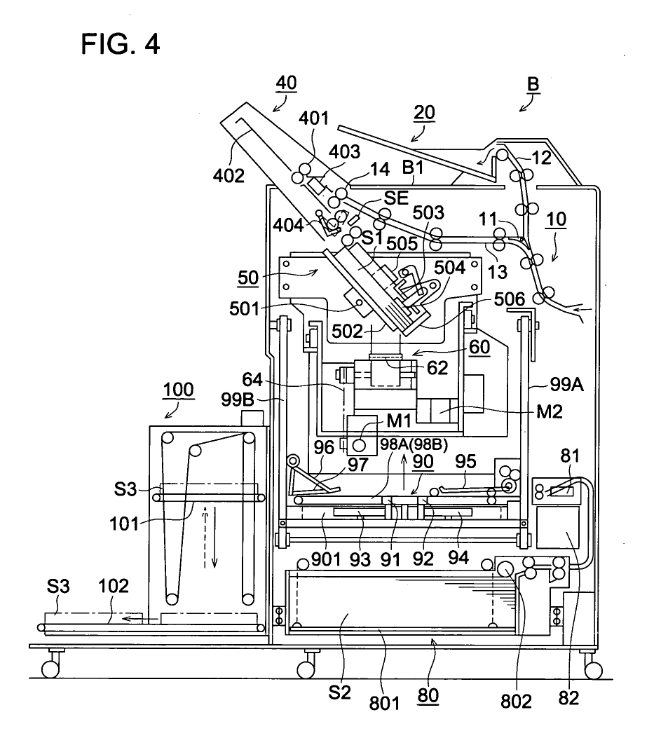

FIG. 4 is a front sectional-view of bookbinding apparatus B.

Sheet S1 conveyed through conveyance path 13 passes through sheet-ejection roller 14 and conveyance roller 401 to be ejected out to reversing guide 402 temporarily. Sheets S1 ejected on the reversing guide 402 are aligned by aligning member 403 in the direction perpendicular to the conveyance direction, and are stacked temporarily by operations of stopper 404. The stopper 404 can be operated between a position of solid lines and a position of dotted lines. When the number of sheets Si stacked temporarily on the reversing-guide 402 arrives at a prescribed value, the stopper 404 is released, and the bundle of sheets S1 falls on stacking section 50. This stacking section 50 has the first holding member 502 and stopper plate 506, and sheets S1 are held obliquely by the first holding member 502 and the stopper plate 506. Lifting of the sheets S1 held obliquely is restrained by holding-down member 504, and the sheets S1 are aligned by aligning plate 505. Then, the second holding member 503 operates to hold the bundle of sheets S1, and sheet-stacking section 50 holding sheets S1 swivels on shaft 501 serving as an axis, whereby, the bundle of sheets S1 is changed in terms of its posture from an oblique direction to a vertical direction.

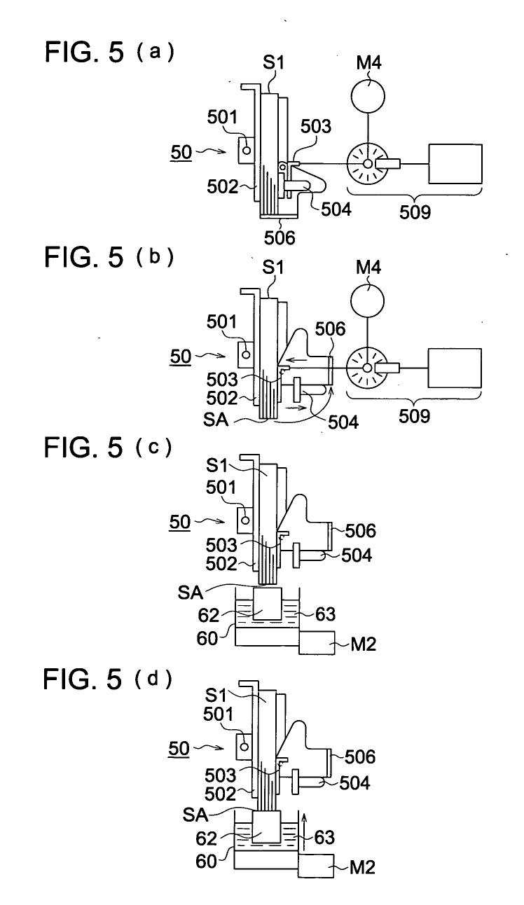

FIG. 5 shows processes of coating adhesive on a bundle of sheets S1.

When the second holding member 503 is moved by motor (moving device) M4 toward sheet S1 to press the sheet S1 at a certain pressure, drive torque detection sensor 510 (not shown) detects an increase of drive torque of motor M4, and the second holding member 503 stops moving. Under the structure of this kind, the bundle of sheets S1 is firmly held by the first holding member 502 and the second holding member 503. A travel distance of the second holding member 503 is measured by encoder 509, and is stored in a storing device such as RAM. Detailed contents of a method for measuring a thickness of a bundle of sheets S1 will be described later.

At the stage when the bundle of sheets S1 is held by the first holding member 502 and the second holding member 503, stopper plate 506 is rotated by a drive mechanism (not shown) by 90° to retreat as shown in FIG. 5(b). Under the condition that the stopper plate 506 is retreated, coating roller 62 is not in contact with bottom surface SA of the bundle of sheets S1 (see FIG. 5(c)).

Next, as shown in FIG. 5(d), when coating section 60 containing therein adhesive goes up and coating roller 62 comes in contact with bottom surface SA representing a spine portion of the bundle of sheets S1, and when the coating section 60 travels along the bottom surface SA of the bundle of sheets S1, adhesive 63 is coated on the bottom surface SA of the bundle of sheets S1. Coating roller 62 is driven by motor M1.

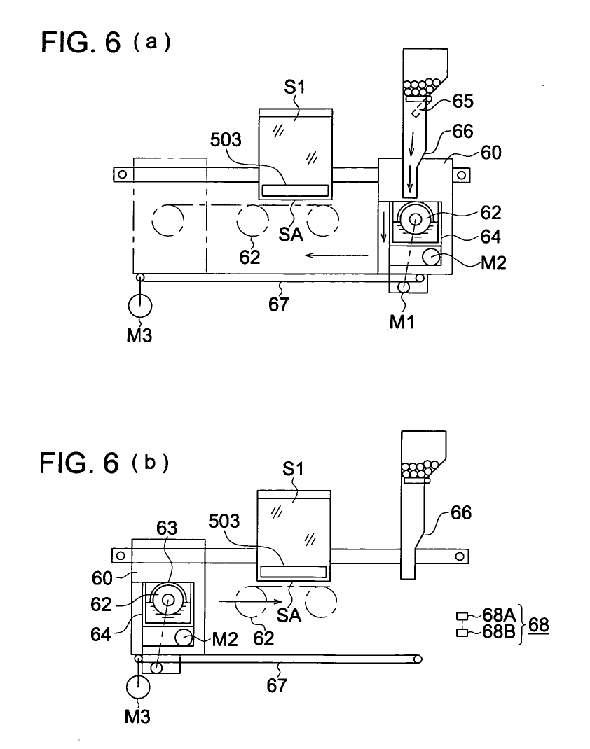

Operations for coating adhesive 63 by coating section 60 will be explained as follows, referring to FIG. 6.

The coating section 60 has therein coating roller 62 that coats adhesive 63 on a bundle of sheets, adhesive 63, adhesive containing section 64 that contains adhesive 63 and a heater (not shown) that melts solid adhesive. Adhesive 63 is contained in adhesive container 66 in the solid condition, and when a residual quantity of adhesive 63 is detected to be small in coating section 60, movable member 65 moves to supply solid adhesive to coating section 60. Then, the solid adhesive is heated by the heater in coating section 60 to be melted in the coating section 60.

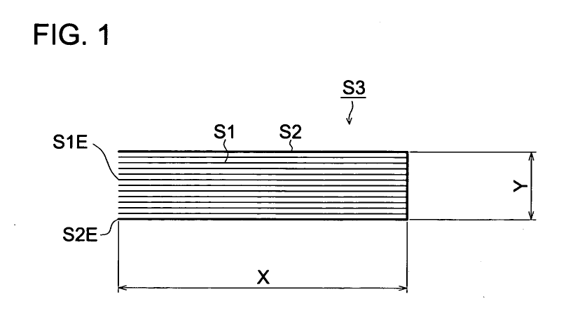

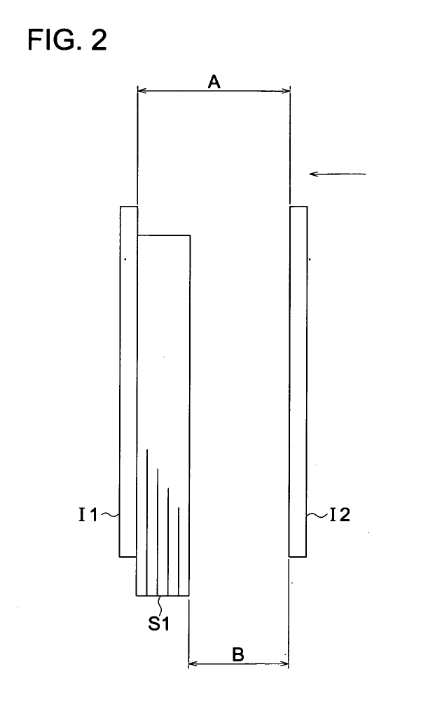

In the starting stage of bookbinding operations, coating section 60 is in the rightmost position representing an initial position (retracted position) in FIG. 6(a). This rightmost position is in a deep side in bookbinding apparatus B, namely, it is a deep side on a page space in FIG. 1, that is opposite to a front door for making a casing of bookbinding apparatus B which houses coating section 60 to be open. Incidentally, this front door will be described later. Further, the initial position is a position being away from the area where adhesive 63 is coated on a bundle of sheets S1 by coating roller 62, and it is preferable that the position is determined by considering the maximum size of a sheet, in the direction perpendicular to the conveyance direction, which can be processed by bookbinding apparatus B. On the rightmost position, there is provided position detection sensor (position detection device) 68 composed of light-emitting element 68A and light-receiving element 68B. If the position detection sensor detects that a part of coating section 60 lies between light-emitting element 68A and light-receiving element 68B, the coating section 60 is judged to be at the retracted position. After the bookbinding operations are started, the coating section 60 moves from the rightmost position to the leftmost position (in the direction toward the front of bookbinding apparatus B). This movement is conducted by driving of belt 67 driven by motor M3. While coating section 60 is moving to the leftmost position, coating roller 62 is away from bottom surface SA of a bundle of sheets S1. Then, at the stage of FIG. 6(b) when coating section 60 is moving from the leftmost position to the rightmost position, the coating roller 62 is lifted by drive of motor M2 to come in contact with the bottom surface SA of the bundle of sheets S1, thus, adhesive 63 is coated. Meanwhile, in FIG. 5(b), coating roller 62 coats adhesive on the bottom surface SA of the bundle of sheets while rotating clockwise-so that a direction of rotation at the point of contact with the bundle of sheets may be the same as the direction of movement of the coating roller.

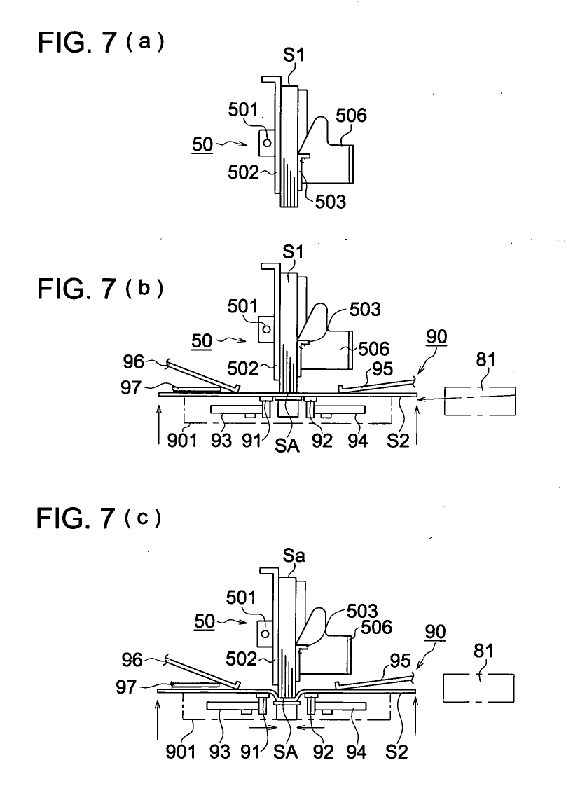

FIG. 7 shows how cover sheet S2 is joined.

As shown in FIG. 4, cover sheet S2 is loaded in sheet-feeding tray 801 of cover sheet loading section 80 that is provided on the lower part of bookbinding apparatus B, and is fed out by feed-out roller 802. The cover sheet S2 thus fed out is cut by cutter 81 to the length appropriate as a cover sheet, and is placed horizontally on cover sheet supporting device 901. The cover sheet supporting device 901 shown with chain lines in FIG. 7, is composed of plural members such as pressure members 91 and 92 and cams 93 and 94 which drive the pressure members 91 and 92. Incidentally, the cutter 81 cuts cover sheet S2 to the prescribed length based on information of a size of sheet S1 and information of a thickness of a bundle of sheets S1. Therefore, as shown in FIG. 1, end on spread side S1E of sheets S1 and end on spread side S2E of cover sheet S2 of book S3 are aligned. Further, cut chips of cover sheets S2 are collected in chip receiver 82.

FIG. 7(a) shows conditions where coating of adhesive 63 is completed. Under the conditions shown in FIG. 7(a), cover sheet supporting device 901 supports cover sheet S2 at the lower position which is away from the bottom surface of the bundle of sheets S1, as shown in FIG. 4.

Next, the cover sheet supporting device 901 is driven by belts 99A and 99B (see FIG. 4) to rise to create the situation shown in FIG. 7(b) wherein cover sheet S2 comes in contact with bottom surface SA of the bundle of sheets S1, namely, with an adhesive coated surface. In the meantime, cover sheet holding members 95, 96 and 97 rise and fall together with the cover sheet supporting device 901. As is shown in FIG. 7(b), therefore, the cover sheet holding members 95, 96 and 97 hold cover sheet S2 from the upper side when the cover sheet supporting device 901 rises, and keep the cover sheet S2 in the state of a plane.

The cover sheet supporting device 901 further rises by a few millimeters from the position of FIG. 7(b). The position corresponding to this rise by a few millimeters is one shown in FIG. 7(c). Pressure members 91 and 92 press the cover sheet S2 from both sides to give a corner to each of a boundary between a spine and a front cover and a boundary between a spine and a back cover sheet, so that cover sheet S2 and sheets S1 may be kept closely together, thus, a book is bound.

The joining process for cover sheet S2 shown in FIG. 7 is started immediately after coating section 60 returns to its initial position in FIG. 6(a). Therefore, the joining process for cover sheet S2 is started right after completion of coating of adhesive 63, whereby, the adhesive 63 coated are not dried before joining, and unsatisfying adhesion caused by drying can be prevented.

Rising and falling of the cover sheet supporting device 901 shown in FIG. 7 are carried out by belts 99A and 99B driven by a motor (not shown), and movements of pressure members 91 and 92 in horizontal directions are carried out by cams 93 and 94 (can forms are shown in FIG. 9) driven by a motor (not shown). However, for pressure members 91 and 92, it is also possible to employ other mechanisms such as the structure to move them through rotation of a pinion engaging with a rack provided on each of pressure members, in addition to the structure for movement by the cams.

Further, under the condition that the cover sheet supporting device 901 shown in FIG. 4 is in its initial position, belts 98A and 98B are in the position shown by solid lines in FIG. 9 representing a top view of the cover sheet supporting device 901, to support cover sheet S2 and conveys it, but in the process where the cover sheet supporting device 901 rises and falls as shown in FIGS. 7(b) and 7(c), belts 98A and 98B move to the retracted position shown with chain lines in FIG. 9 and forms a space to avoid conflict between the belts and cover sheet S2 or a bundle of sheets S1.

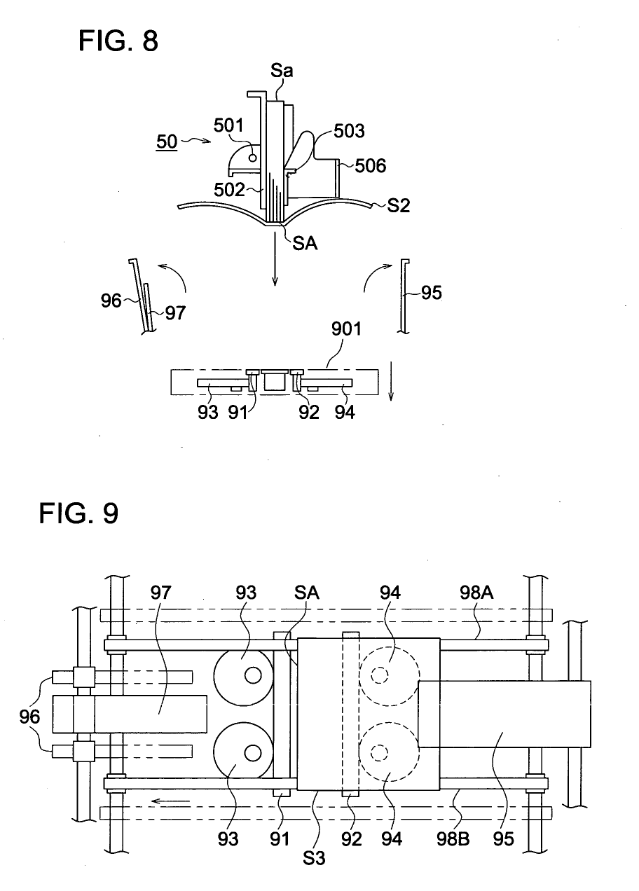

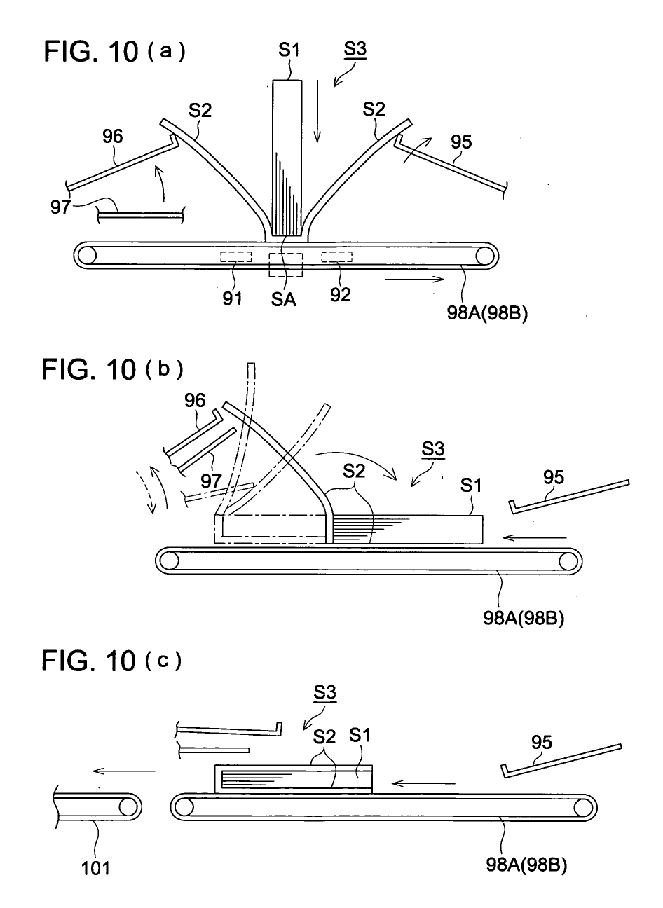

Processing for cover sheet S2 after it is joined will be explained, referring to FIG. 8 and FIG. 10.

After joining of cover sheet S2 is completed, the cover sheet supporting device 901 is driven to lower by belts 99A and 99B to return to its initial position, as shown in FIG. 8. At this time, belts 98A and 98B return to the position shown by solid lines in FIG. 9.

In the returning process in FIG. 8 where the cover sheet supporting device 901 returns to its initial position, each of cover sheet holding members 95-97 rotates on its supporting shaft to become substantially vertical as shown with arrows, but at the stage where they return to their home positions, each of the cover sheet holding members 95-97 swings again to become horizontal from vertical.

After that, the second holding member 503 moves to its retracted position. Owing to this, book S3 composed of a bundle of sheets S1 and of cover sheet S2 falls onto the belts 98A and 98B above the cover sheet supporting device 901. FIG. 10(a) shows the condition wherein book S3 is supported by the belts 98A and 98B above the cover sheet supporting device 901, and the cover sheet holding members 95-97 are positioned under the cover sheet S2.

Under the condition of FIG. 10(a), belts 98A and 98B start moving as shown with arrows, and the cover sheet holding members 95-97 swing to push up cover sheet S2. Book S3 is conveyed toward the left side by belts 98A and 98B, and falls toward the right side as shown in FIGS. 10(b) and 10(c) because movements of their upper portions are obstructed by cover sheet holding members 96 and 97 and falls onto belts 98A and 98B. When they are further conveyed, cover sheet S2 is held by the cover sheet holding members 96 and 97 to come in close contact with sheets S1 as shown in FIG. 10(c).

Book S3 is conveyed by belts 98A and 98B to be ejected to book-ejecting section 100 in FIG. 4.

Sheet-ejection table 101 moves up and down through belt driving, and sheet-ejection table 101 on which book S3 is placed moves down to hand over the book S3 to belt 102, thus, the book S3 is conveyed by the belt 102 to be ejected out of bookbinding apparatus B.

The method to form book S3 in bookbinding apparatus B has been explained, and now, operations to cut cover sheet S2 to an appropriate length will be explained here.

As described above, cover sheet S2 is cut by cutter 81 to an appropriate length as a cover sheet. The appropriate length as a cover sheet is calculated based on a width (X in FIG. 1) included in size information of sheet S1 and on a thickness of a bundle of sheet S1. The thickness of the bundle of sheet S1 is calculated by a difference between an amount of an initial gap formed by the first holding member 502 and the second holding member 503, and a travel distance of the second holding member 503 until it comes in contact with sheet S1. “Initial gap” is a gap which serves as a reference for measuring a thickness of a bundle of sheet S1, and it is a distance between the first holding member and the second holding member before they move. Since the second holding member 503 moves in the present embodiment, the “initial gap” is under the condition-that the second holding member 503 is arranged in its initial position, and it corresponds to a distance between a position of the second holding member 503 before it moves and a position where the first holding member 502 is fixed. As described above, an initial gap between the first holding member 502 and the second holding member 503 varies subtly between the machines, because of an influence of parts accuracy. Therefore, if an initial gap is not measured for every machine, a thickness of a bundle of sheets S1 cannot be measured accurately, and end on spread side S1E and end on spread side S2E of book S3 are not aligned. Accordingly, measuring operations to measure an initial gap between the first holding member 502 and the second holding member 503 are necessary.

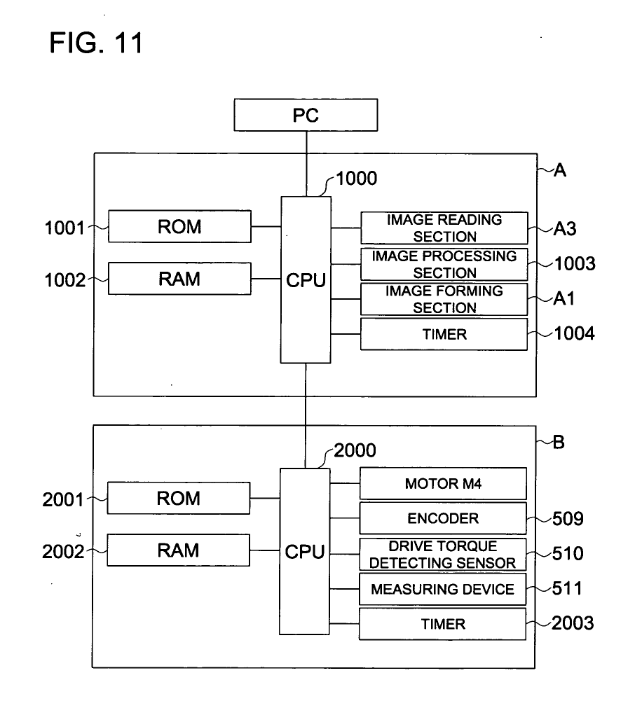

FIG. 11 is a block diagram of a control system in an image forming system, and only typical one is shown here.

To image forming apparatus A, PC representing a terminal, and bookbinding apparatus B are connected. On the image forming apparatus A, CPU (control device) 1000 is provided, and on the bookbinding apparatus B, CPU (control device) 2000 is provided. Both CPUs are connected to each other and control series of operations in each apparatus. To the CPU 2000, there are connected motor (moving device) M4 that moves the second holding member 503, encoder 509 that measures a travel distance of the second holding member 503, and drive torque detection sensor 510 that detects drive torque of motor M4. There is further connected a measuring device that measures a thickness of a bundle of sheets S1 by operating the motor M4 and thereby by holding a bundle of sheets S1 between the first holding member 502 and the second holding member 503. Each of timers (time measuring device) 1004 and 2003 is one to measure elapsed time from the moment to turn on power for each of image forming apparatus A and bookbinding apparatus B.

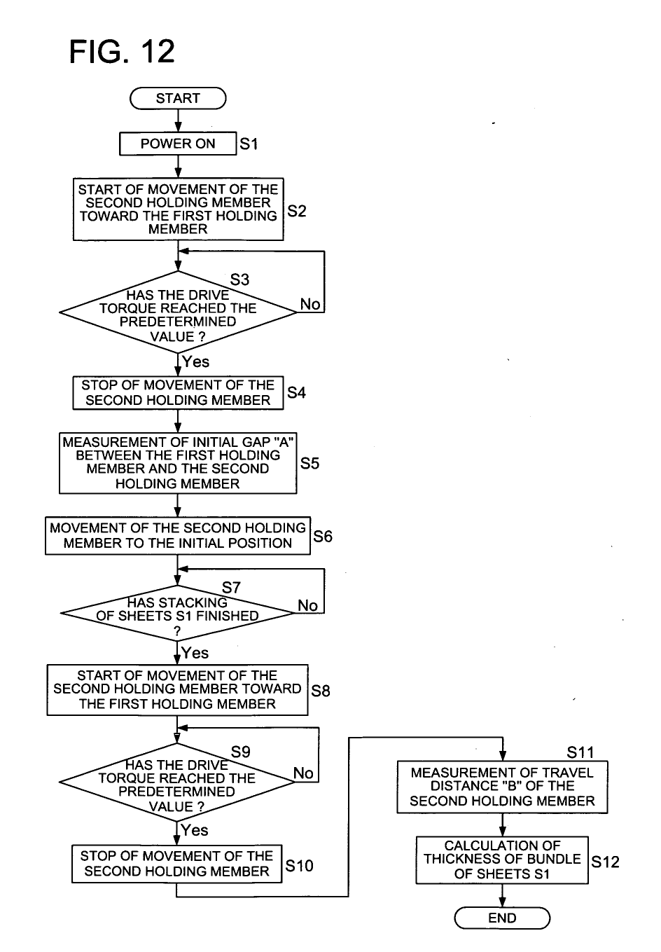

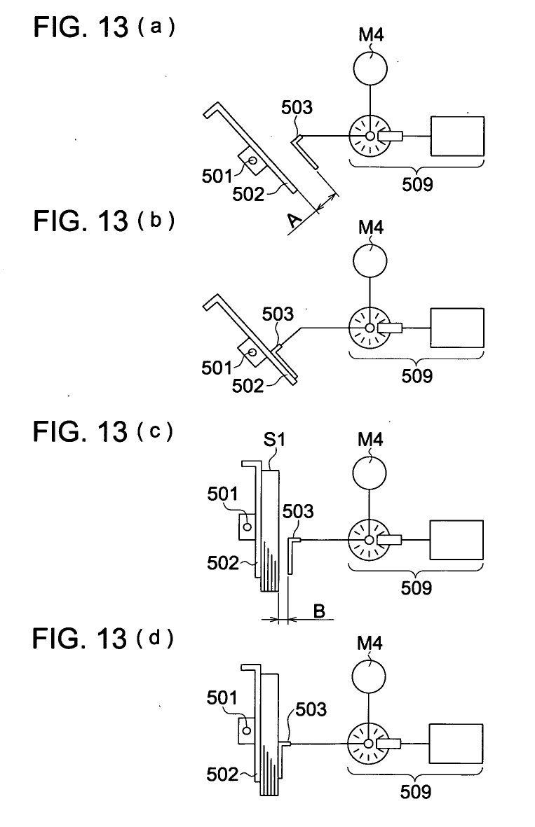

Next, operations to detect a thickness of a bundle of sheets S1 will be explained by using FIG. 12 and FIG. 13.

FIG. 12 is a flow chart showing operations for measuring a thickness of a bundle of sheets S1, and FIG. 13 is an illustration concerning operations of the first holding member 502 and the second holding member 503. For easy understanding of the measuring method, unnecessary members are omitted in FIG. 13.

FIG. 13(a) shows the condition where a bundle of sheets S1 is not stacked between the first holding member 502 and the second holding member 503, and both holding members are inclined. Incidentally, the second holding member 503 is located in its initial position. Under this condition, there are conducted measuring operations to measure initial gap “A” between the first holding member 502 and the second holding member 503.

First, when power is turned on for bookbinding apparatus B in the image forming system (S1 in FIG. 12), a program for measuring initial gap “A” is read out from ROM 2001, and CPU 2000 conducts measuring operations. CPU 2000 operates motor M4 to cause the second holding member 503 to move toward the first holding member 502 (S2 in FIG. 12). Then, drive torque detection sensor 510 detects whether the drive torque of motor M4 has arrived at a prescribed value or not (S3 in FIG. 12). When the drive torque of motor M4 is detected to have arrived at the prescribed value, the movement of the second holding member 503 is stopped (S4 in FIG. 12). When the movement of the second holding member 503 is stopped, the first holding member 502 and the second holding member 503 are in contact with each other as shown in FIG. 13(b). Since a travel distance of the second holding member 503 has been measured by encoder 509, this travel distance results in initial gap “A” between the first holding member 502 and the second holding member 503 (S5 in FIG. 12). If measuring operations for initial gap “A” are conducted as stated above, a value which serves as a reference for measuring a thickness of a bundle of sheet S1 can be measured accurately, and a thickness of a bundle of sheets S1 can be measured accurately without being influenced by parts accuracy. The measured initial gap “A” is stored in RAM 2002. After measurement of initial gap “A” is completed, the second holding member is moved to the initial position (S6 in FIG. 12) for stacking a bundle of sheets S1.

Next, after stacking of sheets S1 is completed (S7 in FIG. 12), the first holding member 502 and the second holding member 503 rotate around shaft 501 serving as an axis while keeping the initial gap “A” to become vertical from the inclined condition. Then, a program for measuring a thickness of a bundle of sheets S1 is read out from ROM 2001, and operations for measurement are carried out by measuring device 511. First, the second holding member 503 is moved toward the first holding member 502 (S8 in FIG. 12). Then, drive torque detection sensor 510 detects whether a drive torque of motor M4 has arrived at a prescribed value or not (S9 in FIG. 12). When the drive torque of motor M4 is detected to have arrived at the prescribed value, a movement of the second holding member 503 is stopped (S10 in FIG. 12). When the movement of the second holding member 503 is stopped, the second holding member 503 and sheets S1 are in contact each other as shown in FIG. 13(d). A travel distance of the second holding member (B in FIG. 13(c)) has been measured by encoder 509 (S11 in FIG. 12). Then, measured initial gap “A” is read out from RAM 2002, and travel distance “B” is subtracted from the initial gap “A” to calculate a thickness of a bundle of sheets S1 (S12 in FIG. 12). A length of cover sheet S2 is determined based on the measured thickness of the bundle of sheets S1 and on size information of sheets S1, and the cover sheet S″ is cut by cutter 81 to an appropriate length. As a result, end on spread side S1E and end on spread side S2E of book S3 resulted from the foregoing are aligned accurately as shown in FIG. 1.

Further, if the initial gap “A” is measured when the power is turned on, the initial gap “A” does not need to be stored under the condition where the power is turned off, whereby, the storage capacity can be reduced. Further, by measuring initial gap “A” each time the power is turned on, the initial gap “A” after any change of the gap is caused can be measured, even when initial gap “A” is changed by position shifting of the first and second holding members 502 and 503 after installation of the bookbinding apparatus, thus, a thickness of sheets can be measured accurately.

In the meantime, though measuring device 511 is provided to measure a thickness of a bundle of sheets S1, an embodiment wherein a program to measure a thickness of a bundle of sheets S1 is read out from ROM 2001 and a thickness of a bundle of sheets S1 is measured by CPU 2000 and an embodiment wherein a program to measure a thickness of a bundle of sheets S1 is read out from ROM 1001 and a thickness of a bundle of sheets S1 is measured by CPU 1000 can offer the effects which are exactly the same as those by the aforesaid measuring device 511.

When a certain time period elapses after the power is turned on for a bookbinding apparatus, there is a possibility that a temperature in the apparatus rises, and initial gap “A” between the first holding member 502 and the second holding member 503 is varied by an influence of heat. It is therefore preferable that the initial gap “A” is measured periodically. Thus, there will be explained the operations to calculate initial gap “A” when a prescribed time period elapses after the power is turned on.

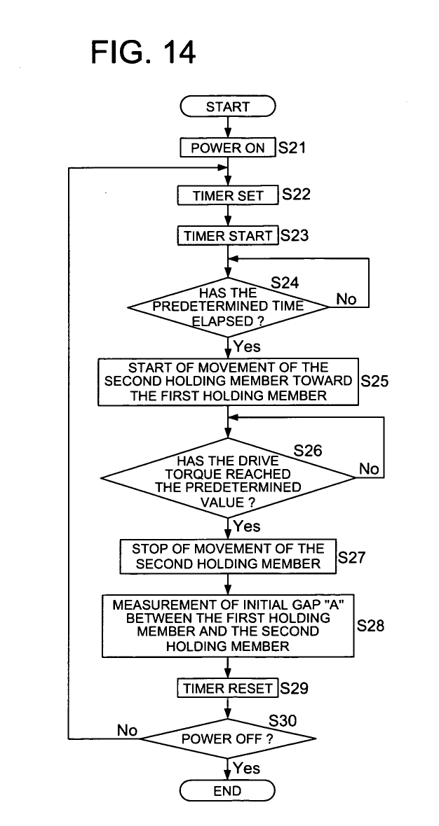

FIG. 14 is a flow chart showing operations for measuring initial gap “A” by using a timer. After the power for bookbinding apparatus B is turned on (S21), timer (time measuring device) 1004 or 2004 is set (S22) and starts (S23). When the power is turned on, operations from S2 to S6 explained in FIG. 12 are conducted. After that, when a prescribed time period elapses (S24), the program for measuring initial gap “A” is read out from ROM 2001, and CPU 2000 conducts measuring operations. The CPU 2000 operates motor M4 to cause the second holding member 503 to move toward the first holding member 502 (S25). Then, drive torque detection sensor 510 detects whether the drive torque of motor M4 has arrived at a prescribed value or not (S26). If the drive torque of motor M4 is detected to have arrived at the prescribed value, a movement of the second holding member 503 is stopped (S27). Since the travel distance of the second holding member has been measured by encoder 509, this travel distance results in the initial gap “A” between the first holding member 502 and the second holding member 503 (S28). The initial gap “A” thus measured is stored in RAM 2002 to be used for coming measurement of a thickness of a bundle of sheets S1. Then, the timer is reset (S29), and the power is judged whether it has been turned off or not (S30), and when the power is not turned off, operations from S22 to S30 are conducted again. By doing this, it is possible to measure a thickness of a bundle of sheets S1 accurately, even when the initial gap “A” is varied by heat.

In the present embodiment, there has been explained a method to measure a thickness of a bundle of sheets S1 by moving the second holding member 503 with motor M4. However, it is also possible to employ another embodiment wherein the first holding member 502 is moved, without being limited to the embodiment wherein the second holding member 503 is moved. It is further possible to employ an embodiment to measure a thickness of a bundle of sheets S1 by connecting a motor and an encoder to each of both the first holding member 502 and the second holding member 503 and by moving both holding members.

The present embodiment is an image forming system wherein bookbinding apparatus B and image forming apparatus A are connected. However, the same effects as those of the aforesaid image forming system can be exhibited by an embodiment of a single image forming apparatus having therein a bookbinding section and an image forming section wherein bookbinding apparatus B and image forming apparatus A are united solidly. After all, the invention can be realized in various embodiments including an image forming apparatus having therein a bookbinding section and an image forming section in addition to a bookbinding apparatus and an image forming system.

The bookbinding apparatus and the image forming system relating to the present invention make it possible to measure a thickness of a bundle of sheets accurately.

What is claimed is:

1. A bookbinding apparatus which binds a book by stacking a plurality of sheets to generate a bundle of sheets and by wrapping the bundle of sheets with a cover sheet in a U-shaped form, the bookbinding apparatus comprising:
a first holding member for holding the bundle of sheets;
a second holding member which is arranged to have an initial gap between the first holding member and the second holding member when the second holding member is in an initial position;
a moving device for moving at least the second holding member from the initial position;
a measuring device for measuring a thickness of the bundle of sheets by causing the moving device to operate so that the first holding member and the second holding member hold the bundle of the sheets; and
a control device for practicing a measuring operation so as to measure the initial gap between the first holding member and the second holding member.

2. The bookbinding apparatus of claim 1,
wherein the measuring device measures the thickness of the bundle of sheets based on an initial gap value measured in the measuring operation and a travel distance of the second holding member from the initial position.

3. The bookbinding apparatus of claim 1 further comprising:
a storing device for storing the initial gap value measured in the measuring operation,
wherein the measuring device measures the thickness of the bundle of sheets based on the initial gap value read from the storing device.

4. The bookbinding apparatus of claim 1,
wherein the measuring operation for measuring the initial gap is conducted when power of the bookbinding apparatus is turned on.

5. The bookbinding apparatus of claim 1 further comprising:
a time measuring device for measuring an elapsed time period since a time-measurement starting time,
wherein when the elapsed time period measured by the time measuring device arrives at a predetermined time period, the measuring operation for measuring the initial gap is conducted.

6. The bookbinding apparatus of claim 5,
wherein the control device conducts the measuring operation and stores the initial gap value in the storing device at the time-measurement starting time and if the elapsed time period measured by the time measuring device is shorter than a predetermined time period, the measuring device measures the thickness based on the initial gap value measured at the time-measurement starting time and if the elapsed time period measured by the time measuring device has arrived at the predetermined time period, the control device conducts the measuring operation to remeasure the initial gap and store an remeasured initial gap value in the storing device and the measuring device measures the thickness based on the remeasured initial gap value.

7. The bookbinding apparatus of claim 5,
wherein the time-measurement starting time is when power of the bookbinding apparatus is turned on.

8. The bookbinding apparatus of claim 5,
wherein the time-measurement starting time is when a last measuring operation for measuring the initial gap is conducted.

9. The bookbinding apparatus of claim 1 further comprising:
a coating section for coating adhesive on a spine portion of the bundle of sheets; and
a cover sheet joining section for joining a cover sheet on the spine portion where adhesive has been coated.

10. The bookbinding apparatus of claim 1 further comprising:
an image forming device for forming an image on a sheet,
wherein the bookbinding apparatus stacks sheets on each of which an image has been formed by the image forming device so as to generate the bundle of sheets.

11. An image forming system in which a bookbinding apparatus which binds a book by stacking a plurality of sheets to generate a bundle of sheets and by wrapping the bundle of sheets with a cover sheet in a U-shaped form and an image forming apparatus which forms an image on a sheet are connected to each other, the image forming system comprising:
a first holding member for holding the bundle of sheets;
a second holding member which is arranged to have an initial gap between the first holding member and the second holding member when the second holding member is in an initial position;
a moving device for moving at least the second holding member from the initial position;
a measuring device for measuring a thickness of the bundle of sheets by causing the moving device to operate so that the first holding member and the second holding member hold the bundle of the sheets; and
a control device for practicing a measuring operation to measure the initial gap between the first holding member and the second holding member.

12. The image forming system of claim 11,
wherein the measuring device measures the thickness of the bundle of sheets based on an initial gap value measured in the measuring operation and a travel distance of the second holding member from the initial position.

13. The image forming system of claim 11 further comprising:
a storing device for storing the initial gap value measured in the measuring operation,
wherein the measuring device measures the thickness of the bundle of sheets based on the initial gap value read from the storing device.

14. The image forming system of claim 11,
wherein the measuring operation for measuring the initial gap is conducted when power of the bookbinding apparatus or power of the image forming apparatus is turned on.

15. The image forming system of claim 11 further comprising:
a time measuring device for measuring an elapsed time period since a time-measurement starting time,
wherein when the elapsed time period measured by the measuring device arrives at a predetermined time period, the measuring operation for measuring the initial gap is conducted.

16. The image forming system of claim 15,
wherein the control device conducts the measuring operation and stores the initial gap value in the storing device at the time-measurement starting time and if the elapsed time period measured by the time measuring device is shorter than a predetermined time period, the measuring device measures the thickness based on the initial gap value measured at the time-measurement starting time and if the elapsed time period measured by the time measuring device has arrived at the predetermined time period, the control device conducts the measuring operation to remeasure the initial gap and store a remeasured initial gap value in the storing device and the measuring device measures the thickness based on the remeasured initial gap value.

17. The image forming system of claim 15,
wherein the time-measurement starting time is when power of the bookbinding apparatus or power of the image forming apparatus is turned on.

18. The image forming system of claim 15,
wherein the time-measurement starting time is when a last measuring operation for measuring the initial gap is conducted.

19. The image forming system of claim 11 further comprising:
a coating section for coating adhesive on a spine portion of the bundle of sheets; and
a cover sheet joining section for joining a cover sheet on the spine portion where adhesive has been coated.
